(19) United States
(12) Patent Application Publication
(10) Pub. No.: US 2013/0054638 A1
(43) Pub. Date: Feb. 28, 2013

(54) SYSTEM FOR DETECTING AND TRACKING TOPIC BASED ON OPINION AND SOCIAL-INFLUENCER FOR EACH TOPIC AND METHOD THEREOF

(71) Applicant: Hyeon Jin KIM, Daejeon (KR)

(72) Inventor: Hyeon Jin KIM, Daejeon (KR)

(73) Assignee: ELECTRONICS & TELECOMMUNICATIONS RESEARCH INSTITUTE, Daejeon (KR)

(21) Appl. No.: 13/592,878

(22) Filed: Aug. 23, 2012

(30) Foreign Application Priority Data
Aug. 24, 2011 (KR) 10-2011-0084704

(51) Int. Cl. G06F 17/30

(52) U.S. Cl. 707/769; 707/E17.014

(57) ABSTRACT

A system capable of detecting and tracking a topic based on an opinion and a social influencer for each topic and a method thereof are provided. The system that detects and tracks the topic based on the opinion and the social influencer for each topic includes: a topic opinion analysis apparatus configured to extract an opinion for each topic from content on the Internet to generate a topic-opinion database (DB), and to extract a social influencer among social members ranked based on behavior characteristics to generate a topic-social influencer DB; a knowledge DB configured to store the topic-opinion DB and the topic-social influencer DB; and a topic detecting and tracking apparatus configured to detect an opinion on a designated topic requested to be searched based on the knowledge DB, search the social influencer of the designated topic, and collect and analyze content provided or generated by the searched social influencer.

### CLAIM FOR PRIORITY

This application claims priority to Korean Patent Application No. 10-2011-0084704 filed on Aug. 24, 2011 in the Korean Intellectual Property Office (KIPO), the entire contents of which are hereby incorporated by reference.

### BACKGROUND

1. Technical Field

Example embodiments of the present invention relate in general to a technique of analyzing a designated topic in a social network environment, and more specifically to an apparatus and a method that can detect and track the topic based on an opinion and a social influencer for each topic.

2. Related Art

As Internet usage continues to increase, many people express their opinions based on an interface such as blogs, news content, social networking services (SNS), or the like on the Internet. In addition, various methods for forming personal connections in a virtual space in which mutual opinions are exchanged via the Internet are continuously presented.

Numerous contents on the Internet include not only information on various topics but also users' opinions on the topics of the Internet. Examples of the contents on the Internet include opinions on news provided in portal sites, consumer reviews in Internet shopping malls, posts of personal blogs, or the like. Recently, a technique for extracting Internet users' opinions and sensitivity included in the contents with respect to various topics has been developed.

As background technology thereof, a Korean Patent Application Publication No. 10-2009-0013928 entitled “Topic extraction apparatus, social network generation system using the topic extraction apparatus, and method thereof” relates to a topic extraction apparatus including a topic extraction unit configured to receive at least one document included in a document database (DB) of a user and to extract a topic of the user from the received at least one document, and a DB configured to include a topic DB for storing the topic extracted from the top extraction unit. In addition, the patent document relates to a social network generation system including a topic DB configured to receive and store objective topics of the respective users from the respective topic extraction apparatuses of the users and a network generation module configured to set personal connections between people having a common objective topic among the users based on information stored in the topic DB.

However, the related art is limited to detecting and tracking the topic by finding what topics are formed in contents on the Internet, within what user groups the formed topics are proliferated, which opinions are present for each topic, and who is an influencer for each opinion.

Therefore, it is necessary to provide a system of detecting and tracking the topic based on the opinion and the social influencer for each topic so as to enable responses of social members on a specific (designated) topic in the content on the Internet to be monitored and enable how the social influencer influences the specific topic to be monitored.

It is also necessary to provide a method of detecting and tracking the topic based on the opinion and the social influencer for each topic so as to enable responses of social members on a specific topic in the content on the Internet to be monitored and enable how the social influencer influences the specific topic to be monitored.

### SUMMARY

Accordingly, example embodiments of the present invention are provided to substantially obviate one or more problems due to limitations and disadvantages of the related art.

Example embodiments of the present invention provide a system for detecting and tracking a topic based on an opinion and a social influencer for each topic, and the system includes: a topic opinion analysis apparatus configured to extract an opinion for each topic from content on the Internet to generate a topic-opinion database (DB), and to extract a social influencer among social members ranked based on behavior characteristics to generate a topic-social influencer DB; a knowledge DB configured to store the topic-opinion DB and the topic-social influencer DB; and a topic detecting and tracking apparatus configured to detect an opinion on a designated topic requested to be searched based on the knowledge DB, search the social influencer of the designated topic, and collect and analyze content provided or generated by the searched social influencer.

Here, the topic opinion analysis apparatus includes: a linguistic analysis unit configured to analyze morphemes of an input sentence forming the content to recognize an entity name; a topic template extraction unit configured to generate a topic template based on a result analyzed by the linguistic analysis unit; a sensitivity analysis unit configured to extract sensitivity words expressed in the input sentence to generate sensitivity information; a topic opinion extraction unit configured to map the sensitivity information to the topic template; and a topic-social influencer extraction unit configured to select the social influencer among the social members that are classified and ranked based on the behavior characteristics for each topic.

Here, the topic-social influencer extraction unit includes: a social influencer analysis unit configured to model and classify the social members based on the behavior characteristics for each topic; a social influencer classification unit configured to give social influence indexes to the social members based on the behavior characteristics; and a social influencer selection unit configured to rank the social influence indexes that are given to the social members and on which social influences are reflected to select the social influencer.

Here, the topic detecting and tracking apparatus includes: an opinion detection and analysis unit configured to detect an opinion on the designated topic requested to be searched based on the topic-opinion DB and to analyze a type of the opinion; a social influencer search unit configured to search and extract the social influencer with respect to the designated topic from the topic-social influencer DB; and a social-influencer-based topic detecting and tracking unit configured to extract a topic and an opinion on the topic of content provided or generated by the social influencer extracted by the social influencer search unit.

Here, the opinion detection and analysis unit includes: an opinion search unit configured to search and extract a topic template corresponding to the designated topic from the topic-opinion DB; an opinion detecting unit configured to extract an attribute of the opinion on the designated topic based on the topic template and the sensitivity information mapped to the topic template; and an opinion type analysis unit configured to analyze and present a type of the opinion on the designated topic based on the attribute of the opinion extracted by the opinion detecting unit.

Here, the social-influencer-based topic detecting and tracking unit includes: a social influencer content search and collection unit configured to search and collect the content provided or generated by the social influencer; a social influencer topic-opinion analysis unit configured to extract a topic and an opinion on the topic from the content searched and collected by the social influencer content search and collection unit; and a social influencer topic tracking unit configured to monitor and present the topic and a change in opinion on the topic extracted by the social influencer topic-opinion analysis unit.

Example embodiments of the present invention also provide a method of detecting and tracking a topic based on an opinion and a social influencer for each topic, the method includes: extracting an opinion and a social influencer among social members that are ranked based on the behavior characteristics for each topic from content on the Internet, and generating a knowledge DB including a topic-opinion DB and a topic-social influencer DB; and detecting an opinion on a designated topic requested to be searched based on the knowledge DB, searching the social influencer of the designated topic, and collecting and analyzing content provided or generated by the searched social influencer.

According to the system and method of the present invention detecting and tracking the topic based on the opinion and the social influencer for each topic, the opinion and the social influencer for each topic can be extracted, responses of the social members on the specific topic can be monitored, and how the social influencer can influence the specific topic can be tracked.

In addition, advantageously, the topic can be extracted from the content on the Internet and to what social members the extracted topics are proliferated can be known.

Effects of the present invention are not limited to the effects mentioned above, and other effects that are not mentioned may be obviously understood by those skilled in the art from the scope of claims.

### BRIEF DESCRIPTION OF DRAWINGS

Example embodiments of the present invention will become more apparent by describing in detail example embodiments of the present invention with reference to the accompanying drawings, in which:

FIG. 1 is a block configuration diagram illustrating a system detecting and tracking a topic based on an opinion and a social influencer for each topic in accordance with an embodiment of the present invention;

FIGS. 2A to 2C are concept diagrams illustrating topic templates and matching between the topic template and sensitivity information in accordance with the present invention;

FIG. 3 is a detailed block configuration diagram of a topic social influencer extraction unit shown in FIG. 1;

FIG. 4 is a concept diagram illustrating modeling on behavior characteristics of social members;

FIG. 5 is a detailed block configuration diagram of an opinion detection and analysis unit shown in FIG. 1;

FIGS. 6A to 6E are concept diagrams each illustrating an attribute of an opinion and a type of an opinion in accordance with the present invention; and

FIG. 7 is a detailed block configuration diagram of a social-influencer-based topic detecting and tracking unit shown in FIG. 1.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred example embodiments in accordance with the present invention will be described in detail with reference to accompanying drawings.

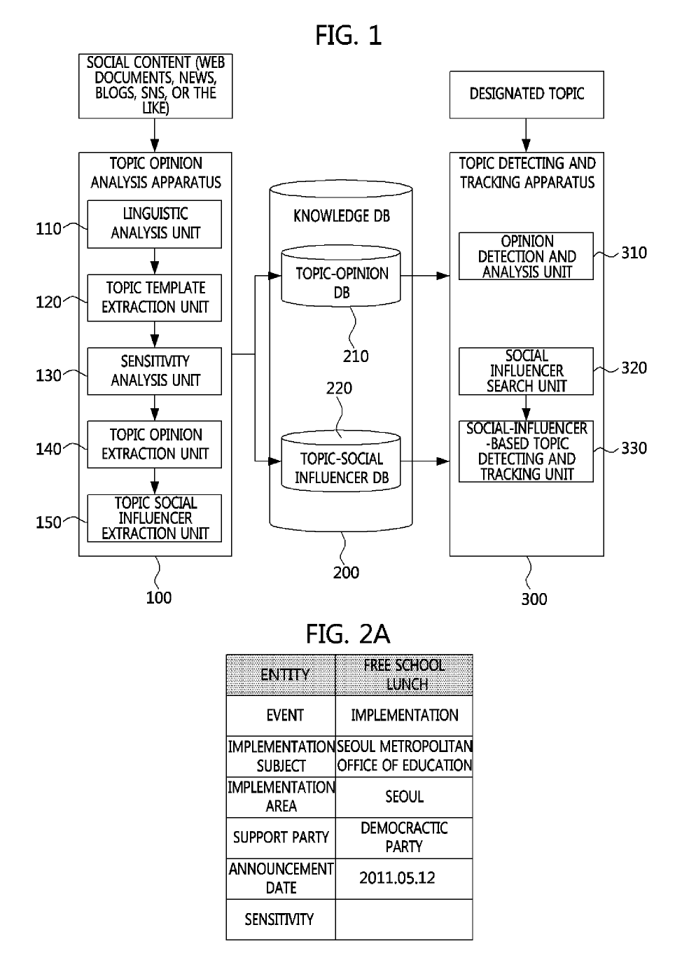

FIG. 1 is a block configuration diagram illustrating a system detecting and tracking a topic based on an opinion and a social influencer for each topic in accordance with an embodiment of the present invention. Referring to FIG. 1, the system according to the present invention is configured to include a topic opinion analysis apparatus 100, a knowledge DB 200, and a topic detecting and tracking apparatus 300.

The topic opinion analysis apparatus 100 receives contents generated in online social networks such as web documents, news, blogs, social networking services (SNS), or the like, and extracts a topic opinion that is an opinion on the topic of users (social members) of the social network or Internet on a specific topic to generate a topic-opinion DB 210. In addition, the topic opinion analysis apparatus 100 extracts a social influencer having a high influence on a specific topic among social members that provide (deliver) or generate contents on the social network such as the blog, SNS, or the like, thereby generating a topic-social influencer DB 220.

The knowledge DB 200 stores the topic-opinion DB 210 and the topic-social influencer DB 220 generated by the topic opinion analysis apparatus 100, and enables the topic detecting and tracking apparatus 300 to detect and track the topic or the opinion based on the knowledge DB 200. Here, the topic-opinion DB 210 may be configured in the form of {topic template, sensitivity information}, and the topic-social influencer DB 220 may be configured in the form of {topic, object, social influencer (IP address, or the like), social influence index}.

The topic detecting and tracking apparatus 300 may detect and track the topic, the topic opinion, the social influencer, or the like, based on the knowledge DB 200 including the topic-opinion DB 210 and the topic-social influencer DB 220 generated by the topic opinion analysis apparatus 100.

The present invention provides a system for detecting and tracking a topic based on an opinion and a social influencer for each topic, the system includes: a topic opinion analysis apparatus 100 configured to extract an opinion for each topic from content on the Internet to generate a topic-opinion DB 210, and to extract a social influencer among social members ranked based on behavior characteristics to generate a topic-social influencer DB 220; a knowledge DB 200 configured to store the topic-opinion DB 210 and the topic-social influencer DB 220; and a topic detecting and tracking apparatus 300 configured to detect an opinion on a designated topic requested to be searched based on the knowledge DB 200, search the social influencer of the designated topic, and collect and analyze content provided or generated by the searched social influencer.

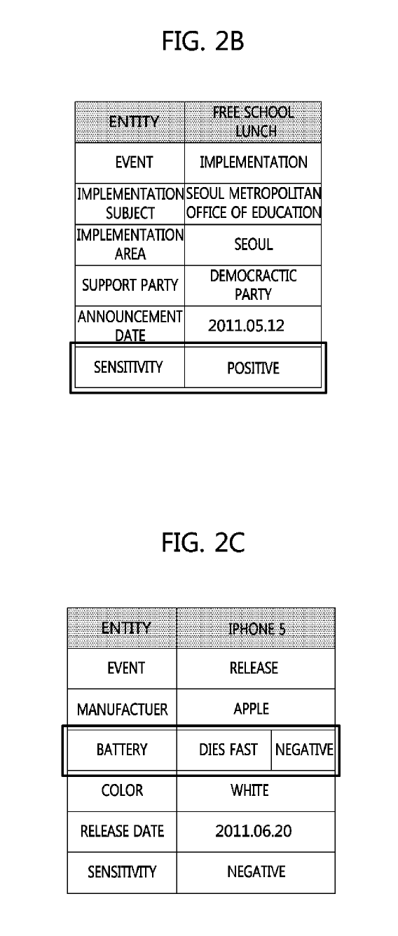

FIG. 2A to 2C are a concept diagrams illustrating a topic template and matching between the topic template and sensitivity information in accordance with the present invention. In the present invention, the topic may be defined to include both an entity, and a combination of the entity and an event.

For example, the definition in the present invention may be defined as follows.

Topic unit: entity, entity+event

Entity: subject of affairs, e.g., free school lunch, savings bank, iPad 2

Event: act by which the entity becomes the subject, or act by which the entity becomes designated (e.g., implementation, dissent, announcement, release, occurrence)

Entity+Event: form in which the entity and the event are integrated as one (e.g., galaxy S2+release, free school lunch+implementation, 4 Major Rivers Project+implementation)

FIG. 2A illustrates an embodiment of a topic template. Referring to FIG. 2A, the topic template may be configured to include an entity (entity name) and an event. For example, the topic template may be configured to include “free school lunch” as the entity and “implementation” as the act, and may also include additional information on the entity. In addition, a structure of the topic template may be separately configured for each topic.

FIGS. 2B and 2C illustrate mapping between the topic template and the sensitivity information, FIG. 2B illustrates “positive” sensitivity information on “free school lunch,” and FIG. 2C illustrates “negative” sensitivity information on the battery of the iPhone 5.

Referring to FIGS. 1 to 2C, the topic opinion analysis apparatus 100 includes a linguistic analysis unit 110, a topic template extraction unit 120, a sensitivity analysis unit 130, a topic opinion extraction unit 140, and a topic social influencer extraction unit 150.

The linguistic analysis unit 110 may analyze the morphemes of the input sentence forming the content on the social network or the Internet to recognize the entity (entity name).

The topic template extraction unit 120 generates the topic template based on the analysis result of the input sentence analyzed by the linguistic analysis unit 110.

The sensitivity analysis unit 130 extracts sensitivity words expressed in the input sentence (“bad,” “good,” “happy,” “angry,” “irritated,” “dissent,” “agree,” or the like) to generate the sensitivity information (highly positive, positive, negative, highly negative, neutral, deferral of judgment, or the like).

The topic opinion extraction unit 140 correspondingly maps the sensitivity information to the topic template.

The topic social influencer extraction unit 150 classifies social members based on behavior characteristics for each topic, gives and ranks social influence indexes, and selects a social influencer with respect to the corresponding topic. Here, the social influence indexes are information in which influences of the social members on the specific topic on the Internet or the social network are numerized.

In addition, the topic detecting and tracking unit 300 included in the system of the present invention may be configured to include an opinion detection and analysis unit 310, a social influencer search unit 320, and a social-influencer-based topic detecting and tracking unit 330.

The opinion detection and analysis unit 310 detects (searches) the opinion on the designated topic based on the topic-opinion DB 210, and analyzes a type of the opinion indicating that the opinion on the designated topic of the users on the Internet or the social network is positive or negative or that the opinion is progressing toward a positive side or a negative side.

The social influencer search unit 320 searches and extracts the social influencer with respect to the designated topic from the topic-influencer DB 220, and sends the social influencer to the social-influencer-based topic detecting and tracking unit 330.

The social-influencer-based topic detecting and tracking unit 330 extracts the topic and topic opinion of the content provided or generated by the social influencer with respect to the designated topic extracted by the social influencer search unit 320.

The topic opinion analysis apparatus 100 included in the system of the present invention may include a linguistic analysis unit 110 configured to analyze morphemes of an input sentence forming the content to recognize an entity name, a topic template extraction unit 120 configured to generate a topic template based on a result analyzed by the linguistic analysis unit, a sensitivity analysis unit 130 configured to extract sensitivity words expressed in the input sentence to generate sensitivity information, a topic opinion extraction unit 140 configured to map the sensitivity information to the topic template, and a topic-social influencer extraction unit 150 configured to select the social influencer among the social members that are classified and ranked based on the behavior characteristics for each topic.

In addition, the topic detecting and tracking apparatus 300 may include an opinion detection and analysis unit 310 configured to detect an opinion on the designated topic requested to be searched based on the topic-opinion DB 210 and to analyze a type of the opinion; a social influencer search unit 320 configured to search and extract the social influencer with respect to the designated topic from the topic-social influencer DB 220; and a social-influencer-based topic detecting and tracking unit 330 configured to extract a topic and the topic opinion of content provided or generated by the social influencer extracted by the social influencer search unit 320.

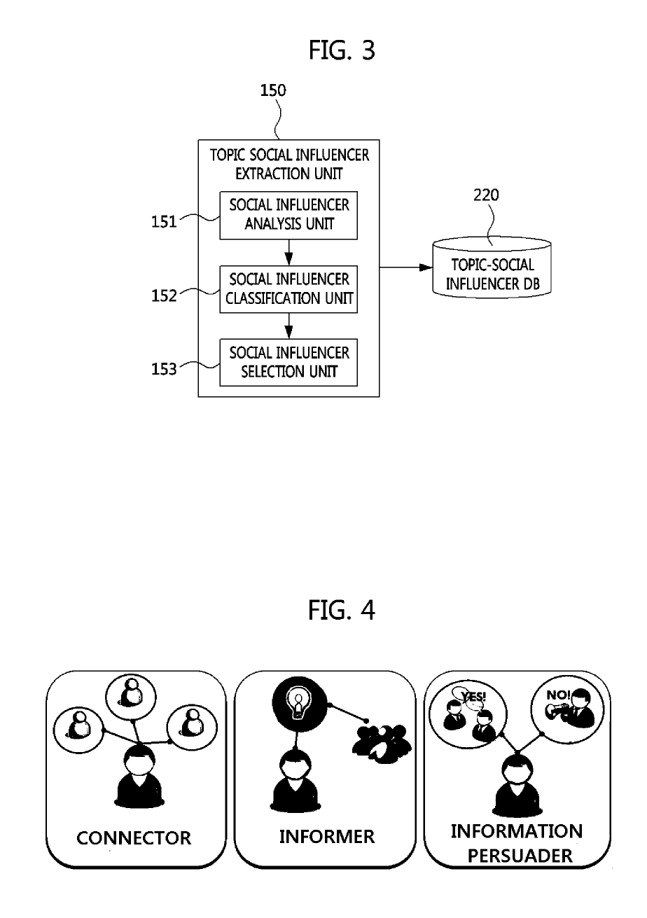

FIG. 3 is a detailed block configuration diagram of a topic social influencer extraction unit shown in FIG. 1. Referring to FIG. 3, the topic social influencer extraction unit 150 is configured to include a social influencer analysis unit 151, a social influencer classification unit 152, and a social influencer selection unit 153.

The social influencer analysis unit 151 models and analyzes the behavior characteristics of the social members for each topic. The behavior characteristics of the social members may be modeled and classified or analyzed as a connector, an informer, an information persuader, or the like, but there is no particular limitation thereon in the present invention.

For example, FIG. 4 is a concept diagram illustrating modeling on behavior characteristics of social members. Referring to FIG. 4, the connector indicates a social member having a high capability of delivering (copying and pasting, retweeting) some information to other social members. The informer indicates a social member that has a great deal of knowledge on some information and generates and delivers new content with respect to the topic. In addition, the information persuader indicates a social member that persuades and incites other social members with respect to some information and generates replies or recommendation information to form a positive or negative response (opinion) on the topic.

The social influencer classification unit 152 may give predetermined social influence indexes in response to the behavior characteristics and degrees of the social members modeled and classified by the social influencer analysis unit 151.

In addition, the social influencer selection unit 153 ranks the social influence indexes that are numerized information on which the social influences of the respective social members are reflected, and selects the social member having a high social influence as the social influencer.

That is, the topic influencer extraction unit 150 includes a social influencer analysis unit 151 configured to model and classify the social members based on the behavior characteristics for each topic, a social influencer classification unit 152 configured to give social influence indexes to the social members based on the behavior characteristics, and a social influencer selection unit 153 configured to rank the social influence indexes that are given to the social members and on which social influences are reflected to select the social influencer.

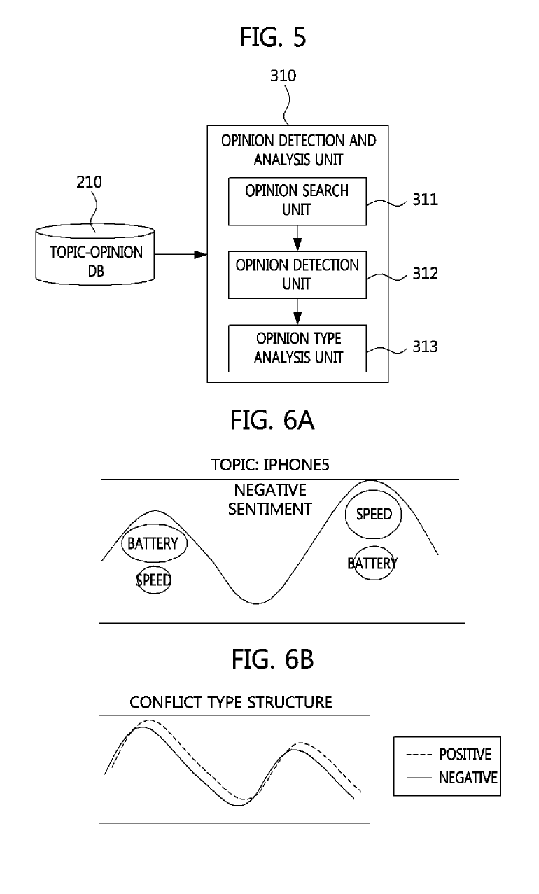

FIG. 5 is a detailed block configuration diagram of the opinion detection and analysis unit shown in FIG. 1. Referring to FIG. 5, the opinion detection and analysis unit 310 is configured to include an opinion search unit 311, an opinion detection unit 312, and an opinion type analysis unit 313.

The opinion search unit 311 searches and extracts the designated topic requested to be searched and a corresponding topic template from the topic-opinion DB 210.

The opinion detection unit 312 extracts the attribute of the opinion on the designated topic based on the topic template and the sensitivity information mapped to the topic template.

The opinion type analysis unit 313 analyzes and presents the type of the opinion on the designated topic based on the attribute of the opinion extracted by the opinion detection unit 312.

Here, the attribute of the opinion indicates by what attribute of the designated topic the sensitivity information is classified based on the sensitivity information on the designated topic such as positive or negative. In addition, the type of the opinion represents the change in sensitivity information on the specific attribute of the topic over time based on the attribute of the opinion.

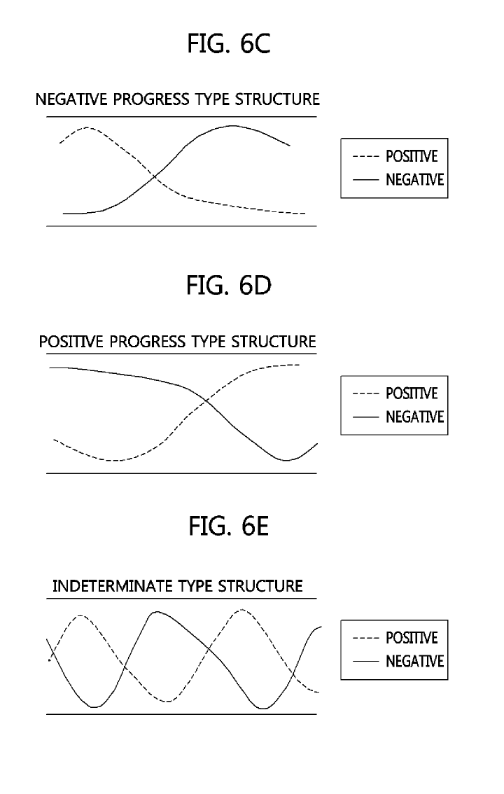

FIGS. 6A to 6E are concept diagrams each illustrating an attribute of an opinion and a type of an opinion in accordance with the present invention. FIG. 6A illustrates the graph of the attribute of the negative opinion on the topic of iPhone 5 and the target of the negative opinion indicates battery and speed. FIGS. 6B to 6E illustrate types of the opinion. FIGS. 6B, 6C, 6D, and 6E illustrate a conflict type structure, a negative progress type structure, a positive progress type structure, and an indeterminate type structure, respectively.

Accordingly, the opinion detection and analysis unit 310 according to the present invention includes an opinion search unit 311 configured to search and extract a topic template corresponding to the designated topic from the topic-opinion DB 210, an opinion detecting unit 312 configured to extract an attribute of the opinion on the designated topic based on the topic template and the sensitivity information mapped to the topic template, and an opinion type analysis unit 313 configured to analyze and present a type of the opinion on the designated topic based on the attribute of the opinion extracted by the opinion detecting unit 312.

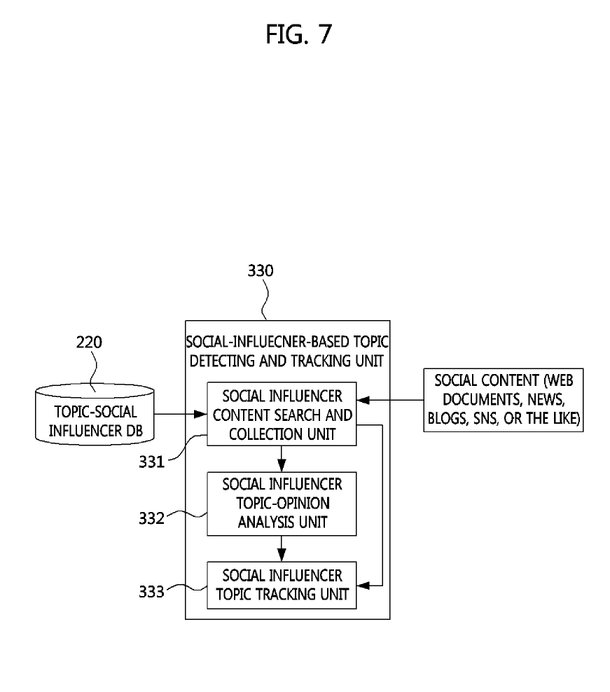

FIG. 7 is a detailed block configuration diagram of the social-influencer-based topic detecting and tracking unit shown in FIG. 1. Referring to FIG. 7, the social-influencer-based topic detecting and tracking unit 330 is configured to include a social influencer content search and collection unit 331, a social influencer topic-opinion analysis unit 332, and a social influencer topic tracking unit 333.

The social influencer content search and collection unit 331 searches and collects the content provided or generated by the social influencer on the Internet or the social network.

The social influencer topic-opinion analysis unit 332 extracts and analyzes the topic and the topic opinion from the content searched or collected by the social influencer content search and collection unit 331.

The social influencer topic tracking unit 333 acts to analyze the topic and the topic opinion of the content provided or generated by the social influencer, and may monitor and present the topic and the change in topic opinion. Accordingly, the social influencer can find the topic of interest and the trend of the topic opinion.

Therefore, the social-influencer-based topic detecting and tracking unit 330 provided by the present invention may be configured to include the social influencer content search and collection unit 331 configured to search and collect content provided or generated by the social influencer, the social influencer topic-opinion analysis unit 332 configured to extract a topic and an opinion on the topic from the content searched and collected by the social influencer content search and collection unit 331, and a social influencer topic tracking unit 333 configured to monitor and present the topic and a change in opinion on the topic extracted by the social influencer topic-opinion analysis unit 332.

The present invention provides a method using the system detecting and tracking the topic based on the opinion and the social influencer for each topic described above.

A method of detecting and tracking a topic based on an opinion and a social influencer for each topic is provided, and the method includes extracting an opinion and a social influencer among social members that are ranked based on the behavior characteristics for each topic from content on the Internet and generating a knowledge DB 200 including a topic-opinion DB 210 and a topic-social influencer DB 220, and detecting an opinion on a designated topic requested to be searched based on the knowledge DB 200, searching the social influencer of the designated topic, and collecting and analyzing content provided or generated by the searched social influencer. Therefore, the opinion on the designated topic requested to be searched can be detected, and the social influencer of the designated topic can be extracted to analyze the content provided or generated by the social influencer, thereby monitoring the influence of the social influencer on the designated topic.

In particular, with respect to the topic opinion analysis step, the step of generating the knowledge DB 200 may include analyzing morphemes of an input sentence forming the content to recognize an entity name and generating a topic template based on the entity name, and extracting sensitivity information from sensitivity words expressed in the input sentence and mapping the sensitivity information to the topic template to generate the topic-opinion DB 210.

In addition, the step of generating the knowledge DB 200 may include modeling and classifying the social members based on the behavior characteristics for each topic and giving social influence indexes to the social members based on the behavior characteristics, and ranking the social influence indexes that are given to the social members and on which social influences are reflected and selecting the social influencer to generate the topic-social influencer DB 220.

That is, according to the step of analyzing the topic opinion of the present invention, the opinion and the social influencer for each topic are extracted from the content on the Internet, and are made to be a DB.

In particular with respect to the step of detecting and tracking the topic, the step of detecting and tracking the topic includes searching and extracting a topic template corresponding to the designated topic from the topic-opinion DB 210 and extracting an attribute of the opinion on the designated topic based on sensitivity information mapped to the topic template, and analyzing and presenting a type of the opinion on the designated topic based on the attribute of the opinion extracted in the searching and extracting step.

In addition, the detecting and tracking of the topic includes searching and collecting content with respect to the designated topic provided or generated by the social influencer and extracting a topic and an opinion on the topic from the searched and collected content, and monitoring and presenting a topic and a change in opinion on the topic extracted in the searching, collecting and extracting step.

According to the present invention described above, the topic can be extracted from the content on the Internet, it can be known to which social members the extracted topics are proliferated, and the opinion and the social influencer for each topic can be extracted. In addition, the response of the social members on the designated topic requested to be searched from the content on the Internet can be monitored, and how the social influencer influences the designated topic can be tracked.

While the example embodiments of the present invention and their advantages have been described in detail, it should be understood that various changes, substitutions and alterations may be made herein without departing from the scope of the invention.

What is claimed is:

1. A system for detecting and tracking a topic based on an opinion and a social influencer for each topic, the system comprising:
a topic opinion analysis apparatus configured to extract an opinion for each topic from content on the Internet to generate a topic-opinion database (DB), and to extract a social influencer among social members ranked based on behavior characteristics to generate a topic-social influencer DB;
a knowledge DB configured to store the topic-opinion DB and the topic-social influencer DB; and
a topic detecting and tracking apparatus configured to detect an opinion on a designated topic requested to be searched based on the knowledge DB, search the social influencer of the designated topic, and collect and analyze content provided or generated by the searched social influencer.

2. The system according to claim 1, wherein the topic opinion analysis apparatus includes:
a linguistic analysis unit configured to analyze morphemes of an input sentence forming the content to recognize an entity name;
a topic template extraction unit configured to generate a topic template based on a result analyzed by the linguistic analysis unit;
a sensitivity analysis unit configured to extract sensitivity words expressed in the input sentence to generate sensitivity information;
a topic opinion extraction unit configured to map the sensitivity information to the topic template; and
a topic-social influencer extraction unit configured to select the social influencer among the social members that are classified and ranked based on the behavior characteristics for each topic.

3. The system according to claim 2, wherein the topic-social influencer extraction unit includes:
a social influencer analysis unit configured to model and classify the social members based on the behavior characteristics for each topic;
a social influencer classification unit configured to give social influence indexes to the social members based on the behavior characteristics; and
a social influencer selection unit configured to rank the social influence indexes that are given to the social members and on which social influences are reflected to select the social influencer.

4. The system according to claim 1, wherein the topic detecting and tracking apparatus includes:
an opinion detection and analysis unit configured to detect an opinion on the designated topic requested to be searched based on the topic-opinion DB and to analyze a type of the opinion;
a social influencer search unit configured to search and extract the social influencer with respect to the designated topic from the topic-social influencer DB; and
a social-influencer-based topic detecting and tracking unit configured to extract a topic and an opinion on the topic of content provided or generated by the social influencer extracted by the social influencer search unit.

5. The system according to claim 4, wherein the opinion detection and analysis unit includes:
an opinion search unit configured to search and extract a topic template corresponding to the designated topic from the topic-opinion DB;
an opinion detecting unit configured to extract an attribute of the opinion on the designated topic based on the topic template and the sensitivity information mapped to the topic template; and
an opinion type analysis unit configured to analyze and present a type of the opinion on the designated topic based on the attribute of the opinion extracted by the opinion detecting unit.

6. The system according to claim 4, wherein the social-influencer-based topic detecting and tracking unit includes:
a social influencer content search and collection unit configured to search and collect the content provided or generated by the social influencer;
a social influencer topic-opinion analysis unit configured to extract a topic and an opinion on the topic from the content searched and collected by the social influencer content search and collection unit; and
a social influencer topic tracking unit configured to monitor and present the topic and a change in opinion on the topic extracted by the social influencer topic-opinion analysis unit.

7. A method of detecting and tracking a topic based on an opinion and a social influencer for each topic, the method comprising:
extracting an opinion and a social influencer among social members that are ranked based on the behavior characteristics for each topic from content on the Internet, and generating a knowledge DB including a topic-opinion DB and a topic-social influencer DB; and
detecting an opinion on a designated topic requested to be searched based on the knowledge DB, searching the social influencer of the designated topic, and collecting and analyzing content provided or generated by the searched social influencer.

8. The method according to claim 7, wherein the generating of the knowledge DB includes:
analyzing morphemes of an input sentence forming the content to recognize an entity name, and generating a topic template based on the entity name; and
extracting sensitivity information from sensitivity words expressed in the input sentence, and mapping the sensitivity information to the topic template to generate the topic-opinion DB.

9. The method according to claim 7, wherein the generating of the knowledge DB includes:
modeling and classifying the social members based on the behavior characteristics for each topic, and giving social influence indexes to the social members based on the behavior characteristics; and
ranking the social influence indexes that are given to the social members and on which social influences are reflected, and selecting the social influencer to generate the topic-social influencer DB.

10. The method according to claim 7, wherein the detecting and tracking of the topic includes:
searching and extracting a topic template corresponding to the designated topic from the topic-opinion DB, and extracting an attribute of the opinion on the designated topic based on sensitivity information mapped to the topic template; and
analyzing and presenting a type of the opinion on the designated topic based on the attribute of the opinion extracted in the step of detecting the opinion.

11. The method according to claim 7, wherein the detecting and tracking of the topic includes:
searching and collecting content with respect to the designated topic provided or generated by the social influencer, and extracting a topic and an opinion on the topic from the searched and collected content; and
monitoring and presenting the topic and a change in opinion on the topic extracted in the searching, collecting and extracting step.
